(19) United States
(12) Patent Application Publication
(10) Pub. No.: US 2024/0046111 A1
(43) Pub. Date: Feb. 8, 2024

(54) METHODS AND APPARATUSES OF DETERMINING FOR CONTROLLING A MULTI-AGENT REINFORCEMENT LEARNING ENVIRONMENT

(71) Applicant: Telefonaktiebolaget LM Ericsson (publ), Stockholm (SE)

(72) Inventors: Kaushik DEY, Kolkata (IN); Perepu SATHEESH KUMAR, Chennai (IN)

(21) Appl. No.: 18/268,655

(22) PCT Filed: Dec. 22, 2020
(86) PCT No.: PCT/IN2020/051039

§ 371 Date: Jun. 21, 2023

(51) Int. Cl. G06N 3/092; G06N 3/045

(52) U.S. Cl. CPC G06N 3/092; G06N 3/045

(57) ABSTRACT

A computer-implemented method includes: obtaining loss functions including: a first loss function associated with a first reinforcement learning, RL, model performed by a first local agent, wherein the first loss function is a function of one or more first parameters; and a second loss function associated with a second RL model at a second local agent, wherein the second loss function is a function of one or more second parameters; determining a combined loss function based on the loss functions; minimizing the combined loss function with respect to the first parameters and the second parameters to determine updated values for the first parameters and updated values for the second parameters; initiating execution of a first updated action by the first local agent based on the updated values of the first parameters; and initiating execution of a second updated action by the second local agent based on the updated values of the second parameters.

### TECHNICAL FIELD

Embodiments described herein relate to methods and apparatuses for controlling a multi-agent reinforcement learning environment.

### BACKGROUND

Reinforcement learning (RL) is an area of machine learning (ML) concerned with how software agents ought to take actions in an environment in order to maximize the notion of cumulative reward. RL is a technique which finds many uses in different applications. An agent may be configured to find an optimal policy to take actions in order to obtain a high reward from the environment it is interacting with.

RL assumes the underlying process is stochastic and follows Markov Decision Process. In Markov Decision Process it is assumed that the current state of the system depends only on one past previous state and not on all previous states. The underlying process is called a “model” in the RL context. Quite often, the underlying model of the system is unknown. In these cases, model-less RL methods such as Q-learning, SARSA etc may be used. There are two functions in RL what are known as a policy function and a value function. The policy function may be described as defining a mapping from perceived states of the environment to actions to be taken when in those states. The value function may be described as defining the expected return if you start in a state or state-action pair and then act according to the policy function thereafter. In many cases the user may specify the value function as computing may not be easy for the system with many actions and states. In some examples, a neural network (deep model) can be used to approximate the value function. This is known as deep RL.

The skilled person will be familiar with neural networks, but in brief, neural networks are a type of supervised machine learning model that can be trained to predict a corresponding output for given input data. Neural networks are trained by providing training data comprising example input data and the corresponding “correct” or ground truth outcome that is desired. Neural networks comprise a plurality of neurons, each neuron representing a mathematical operation that is applied to the input data. The neurons are arranged in a sequential structure such as a layered structure, whereby the output of neurons in each layer in the neural network is fed into the next layer in the sequence to produce an output. The neurons are associated with weights (or parameters) and biases which describe how and when each neuron “fires”. During training, the weights and biases associated with the neurons are adjusted (e.g. using techniques such as backpropagation and gradient descent) until the optimal weightings are found that produce predictions for the training examples that best reflect the corresponding ground truths.

The neural network here takes the states as input and outputs a Q-value for action. A Q-value illustrates how good a certain action is, given a state, for an agent following a policy function. The optimal Q-value function (Q*) describes a maximum return achievable from a given state-action pair by any policy function.

Based on the output Q-value for each available action, the agent will select an action which generates high reward (i.e. has a high Q-value). Here the neural network may be updated based on the actual reward obtained and expected reward. The network is trained when the agent reaches terminal state or number of episodes completed or for a fixed batch size.

In a multi-agent scenario, different agents participate together and work either collaboratively or competitively. A competitive environment is one in which each local agent has its own goals, and those goals may not be complementary to each other in all states.

FIG. 1 illustrates an example of a multi-agent environment. The global goal of the system (comprising two local agents) is to minimize both the bias and variance of the process. This global goal is achieved by two local agents, one which minimizing the bias of the process, and another which minimizing the variance of the process. The two local agents try to achieve the global goal by achieving the local goals. Of course, the two local goals cannot be achieved together and, therefore a trade-off between the two local policies is desired. So, in this process reducing the magnitude of a parameter may reduce variance but increase bias and vice-versa. Hence, in this case, any change in the parameter made by one local agent may affect both the local agents. In this case, we need to handle the agents in a trade-off way to achieve the global goal of the system.

Most problems in multi-agent environments are more complex than the linear graphical analysis expressed in FIG. 1. It is may therefore be desirable to provide a solution to control the agents to achieve a global minima with respect to the loss functions of the multiple agents. Furthermore, it may be desirable for the multiple agents to not attempt to operate the same states simultaneously. Current solutions solve the RL models locally, and obtain a global solution by determining a weighted average of the local solutions. However, this may not be the optimal solution as many times the weightings of the local policies are not known. Also, the individual policies are learnt individually, and the effect of other policies is not known prior to estimation of policy.

A recent paper “Social Influence as Intrinsic Motivation for Multi-Agent Deep Reinforcement Learning” by Natasha Jaques et al of MIT (https://arxiv.orq/abs/1810.08647) attempts to solve the problem by determining the causal influence of one agent's actions on other agents' actions. While this is interesting, often the causal influence may not be visible or is non-existent. For example, if one agent tries to optimize throughput and another agent tries to optimize interference, it may not be possible to find a causal relationship between the two actions or rewards.

Also, for the case of many agents, drawing Pareto curve to determine the weightings is difficult and requires extreme knowledge of the system.

### SUMMARY

According to some embodiments there is provided a computer-implemented method of determining a controlling a multi-agent reinforcement learning environment. The method comprising obtaining a plurality of loss functions comprising: a first loss function associated with a first reinforcement learning, RL, model performed by a first local agent, wherein the first loss function is a function of one or more first parameters; and a second loss function associated with a second RL model at a second local agent, wherein the second loss function is a function of one or more second parameters; determining a combined loss function based on the plurality of loss functions; minimizing the combined loss function with respect to the first parameters and the second parameters to determine updated values for the first parameters and updated values for the second parameters; initiating execution of a first updated action by the first local agent based on the updated values of the first parameters; and initiating execution of a second updated action by the second local agent based on the updated values of the second parameters.

According to some embodiments there is provided a method in a local agent, wherein the local agent is configured to perform a reinforcement learning, RL, model in an environment. The method comprises transmitting, to a global agent, either a loss function associated with the RL model or a replay experience of the agent, wherein the replay experience comprises a state, an action, a reward and a next state, wherein the action is determined based on a maximum Q-value for the state given current values of parameters of the environment; transmitting current values of the parameters to the global agent; receiving updated values of the parameters from the global agent; determining an updated action based on the updated values of the parameters; and performing the updated action.

According to some embodiments there is provided a global agent for controlling a multi-agent reinforcement learning environment. The global agent comprises processing circuitry configured to obtain a plurality of loss functions comprising: a first loss function associated with a first reinforcement learning, RL, model performed by a first local agent, wherein the first loss function is a function of one or more first parameters; and a second loss function associated with a second RL model at a second local agent, wherein the second loss function is a function of one or more second parameters; determine a combined loss function based on the plurality of loss functions; minimize the combined loss function with respect to the first parameters and the second parameters to determine updated values for the first parameters and updated values for the second parameters; initiate execution of a first updated action by the first local agent based on the updated values of the first parameters; and initiate execution of a second updated action by the second local agent based on the updated values of the second parameters.

According to some embodiments there is provided a local agent, wherein the local agent is configured to perform a reinforcement learning, RL, model in an environment. The local agent comprises processing circuitry configured to: transmit, to a global agent, either a loss function associated with the RL model or a replay experience of the agent, wherein the replay experience comprises a state, an action, a reward and a next state, wherein the action is determined based on a maximum Q-value for the state given current values of parameters of the environment; transmit current values of the parameters to the global agent; receive updated values of the parameters from the global agent; determine an updated action based on the updated values of the parameters; and perform the updated action.

The embodiments described above enable for the handling of multiple RL environments, and the trade of between the goals of the multiple agents by converting the multiple RL optimization problems into a single optimization problem that can be solved centrally.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates an example of a multi-agent environment;

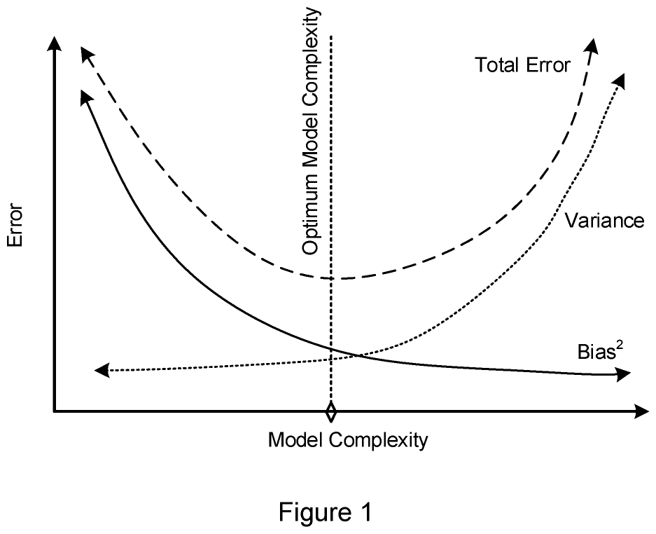

FIG. 2 illustrates a computer-implemented method for controlling a multi-agent reinforcement learning environment;

FIG. 3 is a signaling diagram illustrating an example implementation of the method of FIG. 2;

FIG. 4 illustrates a method in a local agent, wherein the local agent is configured to perform a reinforcement learning, RL, model in an environment;

FIG. 5 illustrates a first local agent operating a first RL model to controls the temperature and a second local agent operating a second RL model to control the water level;

FIG. 6 illustrates an environment in which a car is situated between two mountains and the car is trying to reach destination which is on top of one mountain;

FIG. 7 illustrates an example multi-agent system operating a car in the environment of FIG. 6;

FIG. 8 illustrates a scenario in which multiple floor robots on a warehouse floor are trying to arrange items where they need to plan each episode collaboratively with each other;

FIG. 9 illustrates a global agent comprising processing circuitry (or logic);

FIG. 10 illustrates a local agent comprising processing circuitry (or logic).

### DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Embodiments described herein use distributed learning based reinforcement learning, RL, to compute a trade-off between the local policy functions by creating and minimising a combined loss function. In some embodiments, the combined loss function also ensures the local agents do not try to attempt a conflicting action in the same state. Here, the local agents are assumed to find their own optimal policy by fitting a deep RL model. It will be appreciated that the term “local agent” is used herein to define any software or hardware utilised to implement a deep RL model.

The combined loss function is a single loss function which may be computed in a global agent in order to obtain a global optima. This converts multiple RL optimization problems into a single optimization problem. At every step of the iteration (or every N steps, where N is an integer), based on the combined loss function, individual action values are determined for each of the agents, and the actions are taken by agents. The trade-off is therefore obtained by solving both problems at same time. The method can be extended to any number of local agents easily as the computation may be performed in the cloud which can normally be assumed to be available.

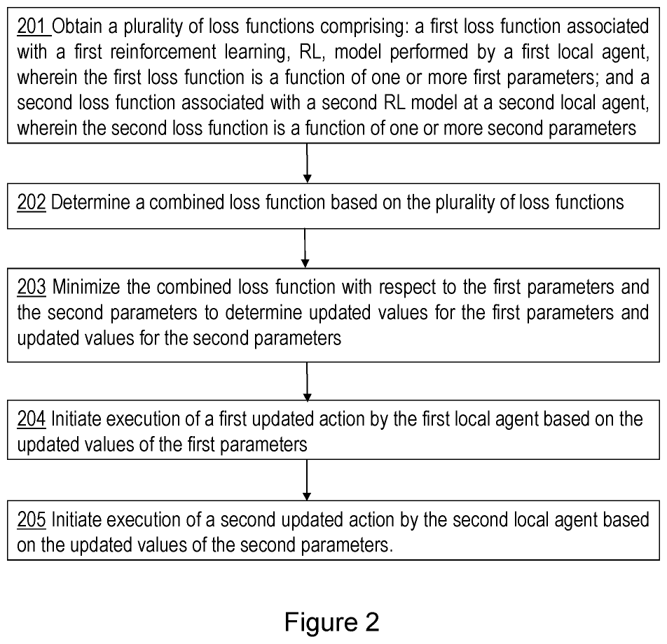

FIG. 2 illustrates a computer-implemented method for controlling a multi-agent reinforcement learning environment. The method of FIG. 2 may be performed by a global agent. The global agent may be implemented in a network node for example an edge cloud node. The global agent may be implemented as a virtual network node.

In step 201, the method comprises obtaining a plurality of loss functions. The plurality of loss functions comprises a first loss function associated with a first reinforcement learning, RL, model performed by a first local agent, wherein the first loss function is a function of one or more first parameters; and a second loss function associated with a second RL model at a second local agent, wherein the second loss function is a function of one or more second parameters.

In some examples, the global agent may comprise one or more of the first local agent and the second local agent. In other words, in some examples the global agent may also perform one or both of the first RL model and the second RL model.

It will be appreciated that the plurality of loss functions may comprise any number of loss functions associated with RL models performed by respective local agents.

For example, the first loss function may be calculated based on a first replay experience of the first local agent, wherein the first replay experience comprises a first state, s_{1,t} a first action, a_{1,t}, a first reward, r_{1,t+1}, and a first next state, s_{1,t+1}. Similarly, the second loss function may be calculated based on a second replay experience of the second local agent. The second replay experience comprises a second state, s_{2,t} a second action, a_{2,t}, a second reward, r_{2,t+1}, and a second next state, s_{2,t+1}.

More generically, a replay experience from an i^{th} agent (where i=1 . . . N, and N is an integer value) used to calculate a local loss function may be denoted (s_{i,t}, a_{i,t+1}, s_{i,t+1})

The first replay experience and the second replay experience may be sampled from replay buffers of the first local agent and the second local agent respectively.

For example, a local loss function for an i^{th} agent may be calculated as (Q_{i,actual}−Q_{i,pred})², where Q_{i,actual} is the target Q-value for the neural network of the agent, and Q_{i,pred} is the predicted Q-value for the neural network of the agent.

In particular:

Q_{i,actual}−{r_{1,t+1}+γᵢₐ_{_{1,t+1}},a_{i,t+1})},Q_{pred}−f(0i,s_{i,t}),

where θᵢ are the parameters (or weights) of the neural network of the agent i, and γᵢ is a weighting factor. Adjusting the value of γᵢ will diminish or increase the contribution of future rewards to the target Q-value.

In some examples, the global agent receives the values of the local loss functions (Q_{i,actual}−Q_{i,pred})² from the each i^{th} agent. In some examples, the global agent receives the replay experiences (e.g. the first replay experience and the second replay experience) and network weights (θi) from the agents i and calculates the loss functions.

In step 202, the method comprises determining a combined loss function based on the plurality of loss functions.

For example, the combined loss function may comprise a sum of the plurality of loss functions.

In some examples, therefore, the combined loss function may be calculated as:

$${I}_{combined} = {\sum }_{i = 1 , …… , N} {{β}_{i} ( {Q}_{actual {l}_{i}} - {Q}_{pred {l}_{i}} )}^{2}$$

where Σᵢ₋₁^{N}βᵢ=1 and the weighting factors βᵢ weight the contribution of the agents to the combined loss. The weighting factors βᵢ can be either static values depending on the underlying Markov Decision Process, MDP, or may be dependent of rewards collected from past time step. It will be appreciated that in some examples, the agents sum may not be a weighted sum.

In step 203, the method comprises minimizing the combined loss function with respect to the first parameters and the second parameters to determine updated values for the first parameters and updated values for the second parameters. For example, step 203 may comprise performing gradient descent on the combined loss function, or any other suitable optimization method.

More generally, the combined loss function may be minimized with respect to the parameters θi for all agents i=1→N to determine updated values for the parameters θ_{i,updated}.

However, the local agents are taking concurrent actions and transitioning to new states without an explicit knowledge of what the next state-action pair of other local agents is.

It may therefore be beneficial to prevent the local agents planning to exploit the same state, as this would be sub-optimal and in many cases counter-productive (For example, you cannot increase and decrease the magnitude of a parameter at same time).

In some examples, therefore the combined loss function further comprises a regularization component, wherein the value of regularization component increases when the first next state, s_{1,t+1} and the second next state, s_{2,t+1}, are closer together.

The regularization component therefore discourages the agents to arrive at a same belief state at the same time. By preventing the agents from arriving at the same belief state at the same time, the method can prevent the agents from colliding.

The regularization component may therefore tries to keep the states of the agents separate from each other throughout the iterations. In a warehouse robot example, this prevents the same robots from attempting to pick the same item and trying to move them to different racks (or even same racks).

For the example of two local agents the combined loss function may be calculated as:

$${I}_{combined} = {( {Q}_{actual {l}_{i}} - {Q}_{pred {l}_{i}} )}^{2} + {( {Q}_{actual {l}_{2}} - {Q}_{pred {l}_{2}} )}^{2} + \frac{δ}{{e}^{\vert d ( {s}_{1 , t + 1} - {s}_{2 , t + 1} ) \vert}}$$

Where,

$$\frac{δ}{{e}^{\vert d ( {s}_{1 , t + 1} - {s}_{2 , t + 1} ) \vert}}$$

is the regularisation component, δ is a regularisation weighting factor (in some cases the regularisation component is not weighted), and the distance d(s₁,s₂) between two states s₁ and s₂ may be calculated as:

d(s₁,s₂)=_{aϵA}^{max}{|rₐ^{s}^{₁}−rₐ^{s}^{₂}|+cTₖ(d)(Pₛ_{₁}^{a},Pₛ_{₂}^{a})},

Where rₐ^{s}^{ᵢ} is a local reward obtained from the state sᵢ after applying the action a, Tₖ(d)(x,y) is the Kantorovich distance between x and y, Pₛ_{ᵢ}^{a} is the of transitioning into the state sᵢ based on the previous state and the action a, A is the combination of all available actions in the first state and the second state, and c is an optional weighting factor. The value of c may be static value. Increasing the value of c would increase the weighting of the probability distributions and lower the weighting of the difference in rewards. In some examples the value of c is 1.

Based on this equation, for the first local agent and the second local agent, step 202 may therefore further comprise: determining the regularization component by determining a distance, d(s_{1,t+1}, s_{2,t+1}), between the first next state and the second next state by:

For each available action aϵA: calculating a reward difference, |rₐ^{s}^{_{1,t+1}}−rₐ^{s}^{_{2,t+1}}|, as a magnitude of a difference between local rewards obtained from the first next state and the second next state after applying the action. In some examples, the distance between the first next state and the second next state may be set as the distance maximum reward distance.

However, in some examples, the method then further comprises calculating a Kantorovich distance between the probability Pₛ_{_{1,t+1}}^{a} of transitioning into the first next state based on the first state and the first action, and the probability Pₛ_{_{2,t+1}}^{a} of transitioning into the second next state based on the second state and the second action; and calculating a distance sum for the action by summing the reward difference and the Kantorovich distance. The distance d(s_{1,t+1}, s_{2,t+1}) between the first next state and the second next state may then be set as the distance sum with the maximum value.

By including the underlying MDP process of all the states in the determination of the distance d(s_{1,t÷1}, s_{2,t+1}) greater differentiation between states is provided.

If d(s_{1,t+1}, s_{2,t+1}) is very small or nearly zero then the regularization component will have a high value and consequently the combined loss will be high. Hence given this expression, the minimization of the combined loss in step 203 will try to keep the states further apart and at the same time try to move Q_{i,pred} closer to C_{i,actual} for both agents.

For N local agents, the combined loss function may be generalized as:

$${I}_{combined} = {\sum }_{i = 1 , …… , N} {{β}_{i} ( {Q}_{actual {l}_{i}} - {Q}_{pred {l}_{i}} )}^{2} + \frac{δ}{2} {‖ {E}^{- 1} ‖}_{F}^{2}$$

where

$$\frac{δ}{2} {‖ {E}^{- 1} ‖}_{F}^{2}$$

is the regularisation component, and

$$where E = [ \begin{matrix}d ( {s}_{1} , {s}_{1} ) & . . & d ( {s}_{1} , {s}_{N} ) \\ d ( s 2 , s 1 ) d ( {s}_{2} , {s}_{N} ) & . . & d ( {s}_{2} , {s}_{N} ) \\ . . & . . & . . \\ d ( {s}_{N} , {s}_{1} ) & . . & d ( {S}_{N} , {S}_{N - 1} )\end{matrix} ] and {\sum }_{i = 1}^{N} {β}_{i} = 1$$

The Frobenius norm ensures all the distances are squared and summed. Since the distances are summed up twice the value is divided by 2 to ensure normalization.

In other words, in some examples the plurality of loss functions comprises N loss functions, where N is an integer, each associated with a respective RL model performed by an i^{th} agent, where i=1, . . . , N, wherein the i^{th} loss function is calculated based on a i^{th} replay experience of the i^{th} agent, wherein the i^{th} replay experience comprises an state, an i^{th} action, an i^{th} reward and an i^{th} next state. In this case, the step of determining the regularization component may comprise calculating distances between each combination of possible pairs of states in: the first next state to the N^{th} next state; calculating a Frobenius norm of a matrix comprising the distances; and setting the regularization component as a square of the Frobenius norm divided by 2.

In step 204, the method comprises initiating execution of a first updated action by the first local agent based on the updated values of the first parameters.

In step 205, the method comprises initiating execution of a second updated action by the second local agent based on the updated values of the second parameters.

In general, the method may comprise initiating execution of updated actions by all N agents based on the updated parameters θ_{i,updated} for i=1, . . . , N.

In some examples the global agent initiates execution of an i^{th} updated action by transmitting the updated values of the i^{th} parameters to the i^{th} agent. The i^{th} agent may then utilize the i^{th} RL model with the i^{th} updated parameters to execute the i^{th} updated action. The updated replay experience of the i^{th} agent may then be transmitted back to the global agent.

The global agent may then repeat the method as described with reference to FIG. 2 until a terminal state is reached. For example, the terminal state may be when the value of the parameters converge, and no further updates are determined by the method of FIG. 2.

The updated local RL models with their terminal parameters may then be used to perform actions in real time.

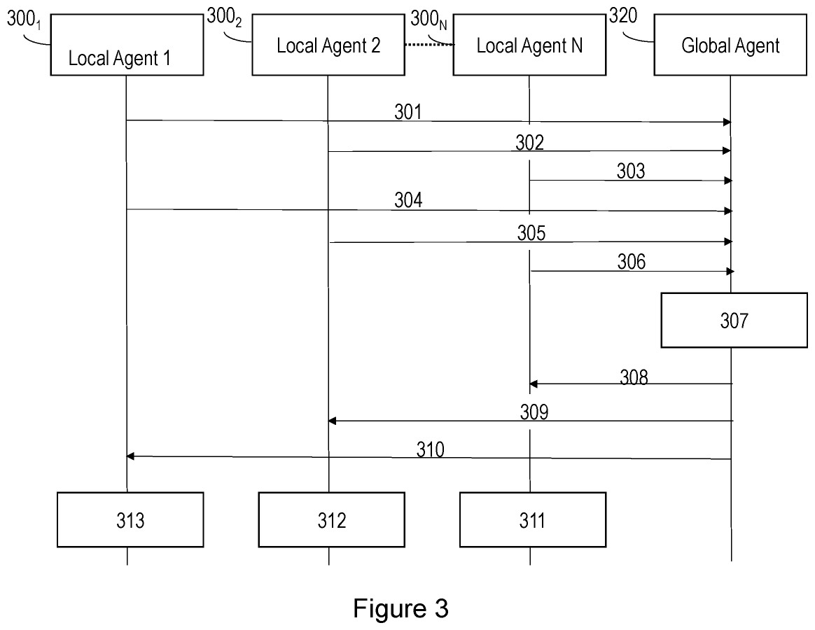

FIG. 3 is a signaling diagram illustrating an example implementation of the method of FIG. 2.

There are N individual local agents 300₁ to 300_{N} which, in steps 301, 302, 303 transmit the current belief state information they are in, actions they took in the last time step and reward they obtained (e.g. the replay experience) to the global agent 320.

The N individual local agents 300₁ to 300_{N} also transmit the weights (parameters) θᵢ of the deep RL network they have to the global agent in steps 304, 305 and 306. All this information may be transmitted to the global agent 320 which may be hosted, for example, in the cloud or common server.

In step 307 the global agent 320 computes the combined loss function for example as describe above with reference to FIG. 2, and minimises the combined loss function.

In steps 308, 309 and 310, the global agent 320 transmits updated weights back to the N individual local agents 300₁ to 300_{N}.

In steps 311, 312 and 313, the local agents 300₁ to 300_{N} will take the updated weights and execute updated actions computed using those updated weights. The local agents will then compute the next state information and will transmit the next relay experience to the global agent 320. The process may then repeat until a terminal state is reached.

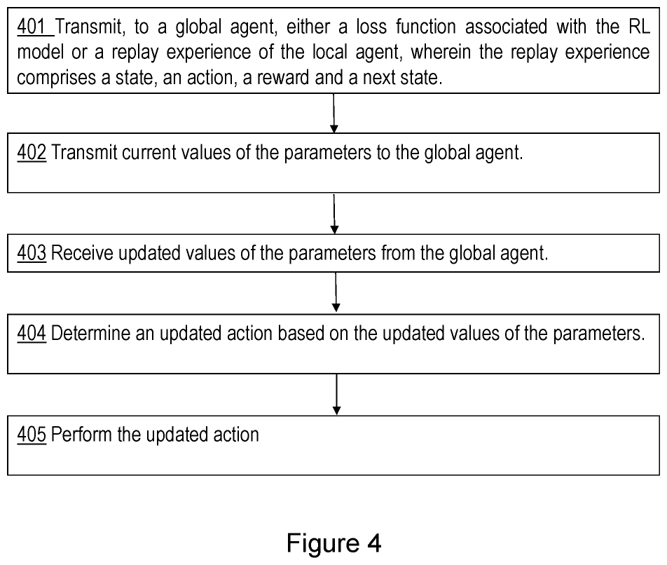

FIG. 4 illustrates a method in a local agent, wherein the local agent is configured to perform a reinforcement learning, RL, model in an environment. The method of FIG. 4 may be performed by any of the plurality of local agents as described with reference to FIGS. 2 and 3.

In step 401, the local agent transmits, to a global agent, either a loss function associated with the RL model or a replay experience of the local agent, wherein the replay experience comprises a state, an action, a reward and a next state. The action is determined based on a maximum Q-value for the state given current values of parameters of the environment. For example, the parameters comprise the weights of a neural network of the RL model.

In step 402, the local agent transmits current values of the parameters to the global agent.

In step 403, the local agent receives updated values of the parameters from the global agent.

In step 404, the local agent determines an updated action based on the updated values of the parameters.

In step 405, the local agent performs the updated action.

It may be assumed that the plurality of agents are working towards the same global goal i.e. either in competing way or collaborating way. In some cases, the local goals of the agents are collaborating and in some cases the local goals of the agents are competitive. In this way, it may be ensured that there exists some correlation between agents at any time. If no correlation exists between some agents, in some examples, only the agents which have correlation are included in the combined loss function.

The proposed approach may be applied to three different perspectives:

1—Multiple Agents with Rewards in a Single Dimension Space, but Actions in Different Dimensions (i.e. Different Agents are Performing Different Actions)

In this perspective, each agent in the system has their own action space and state space. An example may be varying of different KPI's influence on the global state of the process. In this example, it can be seen that two KPI's may affect each other i.e. if one KPI increases, automatically another KPI decreases and vice versa. In this perspective there is only one single reward function which maps the whole system.

For example, consider Transmission Power and Tilt of Antenna in an antenna system. A first local agent may be configured to control a transmission power of an antenna to decrease a Signal-to-Interference-plus-Noise Ratio, SINR, of the antenna, and a second local agent is configuration to control a tilt of the antenna to decrease the SINR of the antenna.

Each agent may therefore receive a reward in terms of SINR decrease, but each agent may need to operate in such a way that action of both agents globally optimize the SINR. Therefore, by utilising the combined loss function, the SINR may be globally optimised.

Consider a different example in which a first local agent is configured to control radio access network counters to minimize handover rate in the radio access network, and a second local agent is configuration to control radio access network counters to maximize Reference Signal Received Power, RSRP, values in the network.

Overall, the global intent is to improve the performance of the tower. This global intent is translated to two local intents (i) RSRP and (ii) hand over rate. These are two local intents which are to be maintained at some specified level to maintain good performance. However, the local intents are contradicting to each other. For example, if the RSRP is increased, then it increases the handover rate of the network and vice versa. Hence, to improve the global performance of the local models the two conflicting parameters may need to be maintained at some specified level.

By utilising the combined loss function as described above, the local agents may try to maximize their individual performance i.e. the second local agent will try to maximize the RSRP (the local policy of the RSRP intent) and the first local agent will try to minimize the hand over rate (the local policy of the hand over rate intent).

To arrive at a state which fully satisfies both the policies is not possible. Hence, it may be desirable to find global state i.e. state of the entire system, as trade-off between these local systems.

In this case, the global system state is measured on the global performance of the state, for example, the value of the packet loss.

Now consider employing the method as described with reference to FIGS. 2 to 4 to this problem. The local policies may be formed as deep RL problems with two fully connected layers. Initially, these local agents may be run for some time without worrying about the performance of the global system. The replay experiences of the two local agents s_{i,t},α_{i,t},r_{i,t+1},s_{i,t+1} may then be stored in a database.

The states of the first local agent is the handover rate, and the states of the second local agent is the value of RSRP. To simplify problem, the state space may be discretized for both the local agents. The action space may also be discretized for both the local agents.

Based on the experience replay, the two local deep RL problems are run locally. Further, with every iteration of the deep RL problems locally, the loss functions of the local models are sent to the global agent, and the combined loss function is calculated. The combined loss function is then minimised using the state information obtained from the local agents. Further, the global state information e.g. packet loss may also be obtained from the system and may be used to update the best action obtained from system. In some examples, the global state information may be included as a term in the combined loss function.

Both RSRP and handover rate depend on actions taken on Radio Access Network (RAN) counters. The available actions for both local agents may well have few counters in common. It may therefore be beneficial to ensure that the local agents do not modify the same counter and hence the regularisation component of the combined loss function comes into use.

Another aspect of the regularisation component is that it will prevent the local agents from coming to the same belief state. In this way, the local agents will be prevented from taking an action which takes the system back to a state which another local agent has already seen. This is achieved by encouraging the local agents to keep a distance between their belief states.

As previously mentioned, the state information in this example is the respective increase in the variables RSRP and Hand over rate. The actions are the values chosen for the RAN counters. In this case, the actions taken are binary: either an increase to the specific counter or a decrease. Without applying the method of FIG. 2, both agents may try to modify the same RAN counter so that they individually obtain a good reward. Of course, this attempt to modify the same RAN counter may degrade the whole system, and as such as these two services are correlated. Hence, the method of FIG. 2 encourages the local agents to choose counters to modify that are not the common counters, so that the local agents achieve good global performance together.

The use of the proposed method of FIG. 2 leads to an improvement of 20% in the performance of the global system performance when compared with the use of a praetor curve as described in the background. In this way, the proposed method can improve the global system performance.

Another example is a Multi-Control Water tank system. In this example, it may be assumed that there exists an open water tank (opened to sky) and that the goal is to control both the level of the water in the tank, and the temperature of the water in the tank. Here there are two local agents which work independently to control the level and temperature of the tank.

However, there is interaction between these two local agents. For example, if temperature of the system starts decreasing, the local agent which monitors temperature may perform an action to switch on a heater. This action may result in more evaporation of the water inside tank and thus the level of the water decreases, negatively affecting the other local agent. In another case, if one local agent increases the level of the water, the temperature of the water may decrease, negatively affecting the other local agent and vice versa. In this way, the actions of the local agents are inter-linked with each other and can affect each-others performance in negative way.

In this example, for the temperature local agent the action space is {switch on heater, switch off heater} and the state space is {temperature greater than a predetermined threshold, temperature lower than a predetermined threshold}. For the water level agent, the action space is {switch on pump, switch off pump} and the state space is {level greater than a predetermined threshold, level lower than a predetermined threshold}.

The global reward is the summation of the closed loop control of water level and temperature systems.

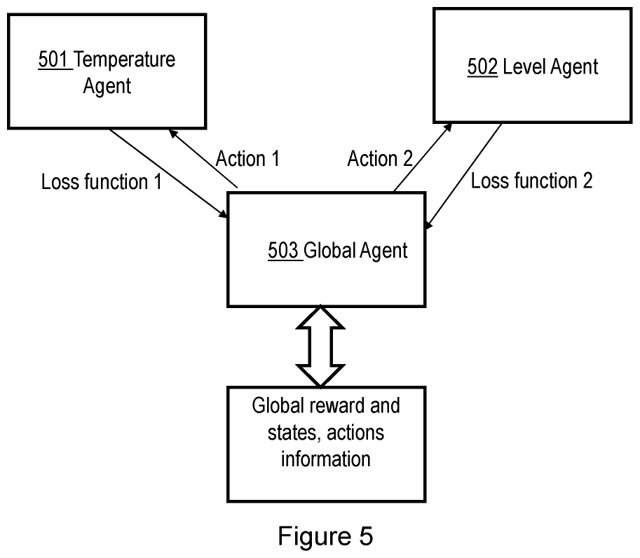

As illustrated in FIG. 5 therefore, a first local agent 501 operates a first RL model to controls the temperature and a second local agent 502 operates a second RL model to control the water level. If the two local agents act independently, the performance of the global system is not satisfactory. On the other hand, by implementing the method of FIG. 2, the performance of the global system can be improved.

As described with reference to FIG. 2 therefore, the loss function (loss function 1 and loss function 2) from each local agent is therefore obtained by a global agent 503, and the combined loss function is calculated as described with reference to FIG. 2. In every iteration (or every N iterations, where N is an integer value), the combined loss function is calculated, minimised, and the updated parameters of the first RL model and the second RL model are calculated. In some examples, the global agent 503 calculates the updated actions for the first local agent and the second local agent. The global agent 503 may therefore transmit the action 1 to the first local agent 501, and the action 2 to the second local agent 502. In other examples, the global agent may transmit the updated parameters determined using the method of FIG. 2 to the local agents.

In this way, the performance of both the local agents can be improved.

2—Multi—Agent but the Reward is in a Multiple Dimension Space Whilst the Actions are in Same Dimension (i.e. Different Local Agents Performing the Same Actions)

In this perspective, the system may be designed as a multi-agent problem with the system trying to optimize two goals, where the individual reward function is measured in different dimensions. Since there are a plurality of agents, the local agents may provide two different recommendations for an action, but only a single action can be employed. The reward is measured in multiple dimension space. For example, consider a car where one local agent is trying to optimise performance and another local agent is trying to optimise safety at same time. The action is limited to either pressing the gas pedal or pressing the brake. Which action to take may be decided based on a global agent and not by the individual local agents. Of course, both objectives may be competing with each other, and the global reward may be measured by optimizing the reward function across both dimensions e.g. in terms of performance and safety.

The aforementioned problem may also be considered as a single agent performing one action, but where the single agent has to satisfy two different competing conditions. For example, if we want to drive the car with high speed but safely, we can perform single action i.e. input to the vehicle and however the reward is measured in two different tasks.

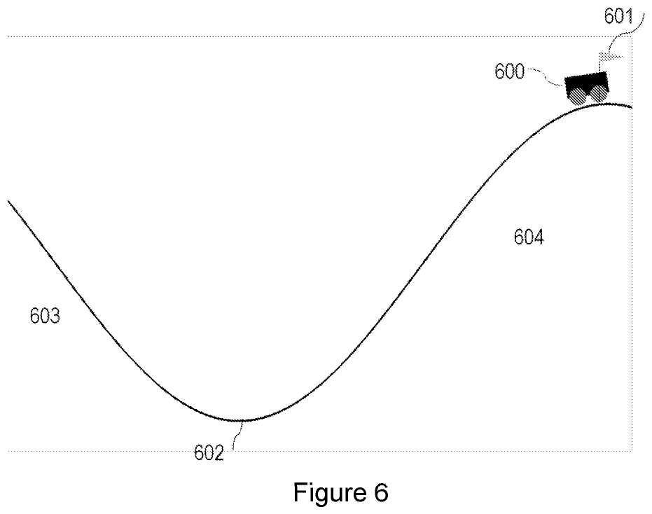

FIG. 6 illustrates an environment in which a car 600 is situated between two mountains and the car is trying to reach destination 601 which is on top of one mountain.

The car is attempting to travel from a starting point 602 to the destination 601 in a minimum number of time steps. In each of the time steps, the car either go forward, go backwards or be idle. The car has a minimum engine power and has to go backwards up the first mountain 603 to climb the second mountain 604 as high as possible. Of course, with every time step, it will consume more fuel and another objective is to reach the destination using a minimum amount of fuel.

The global goal is therefore to reach the destination in the fastest possible time with the minimum fuel consumption. Of course, these two objectives are conflicting and therefore the method of FIG. 2 may be used to solve the global objective.

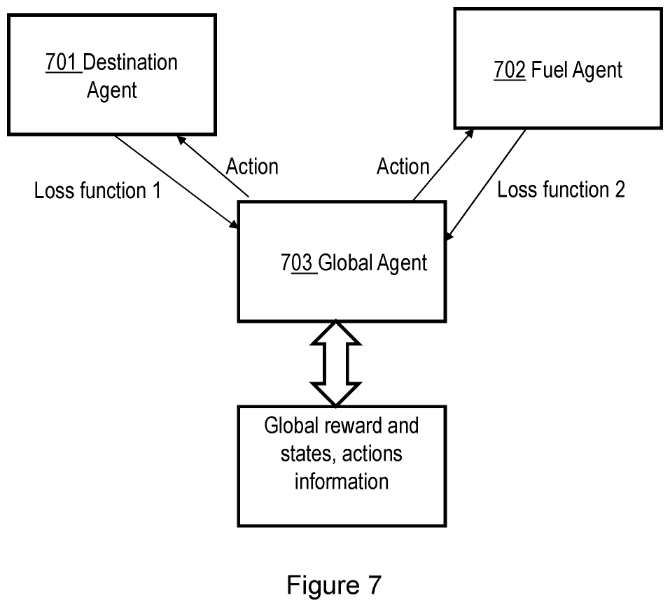

FIG. 7 illustrates an example multi-agent system operating a car in the environment of FIG. 6. In this example, a first local agent 701 works to reach the destination in a minimum time, a second local agent 702 works to reach destination with minimum fuel consumption. Now, the first local agent 701 will get a negative reward for every step it makes without reaching the destination. Similarly, the second local agent 702 will get a negative reward for every step it made in forwards (when not in idle) or backwards. In brief, the first local agent 701 will try to reach destination without worrying about fuel and second local agent 702 will aim to reach the destination without worrying about taking steps. Of course, these local agents are conflicting.

The global reward is total reward obtained in reaching destination. The first local agent 701 aims to reach destination quickly by moving the car backwards and then forwards until it reaches the destination. The second local agent 702 aims to stay idle since making a step backwards or forwards (when not in idle) consumes fuel.

According to method of FIG. 2, the first local agent 701 therefore implements the first RL model aiming to reach the destination quickly, and the second local agent 702 implements the second RL model aiming to conserve fuel. The global reward obtained is a global measure of how well the system is behaving. Overall, the global system tries to reach destination by getting maximum reward.

In a starting of episode the global reward is initialized to zero. For every action in a time step for first local agent 701 either to move forward, backward or idle, the reward from the first RL model is, for example, −1. For every reverse action (or forward action when not in idle) the reward from the second RL model is, for example, −1. Overall, the goal is to maximize the global reward of the system by satisfying both the first local agent and the second local agent requirements.

The first local agent 701 will try to move the car backwards as much as possible to start with to gain potential energy to reach the destination as quickly as possible. However, this implies negative reward for the second local agent 702 as it consumes more fuel. Hence, it may be desirable to obtain a trade-off between these local agents to obtain much higher global reward.

In this example, the single dimension action space is: Forward, Backward and idle. The state space is: Position, Velocity of the vehicle. The Global Reward is: Sum of fuel agent reward and destination agent reward.

To start the process, the local agents 701 and 702 transmit the replay experiences to the global agent 703 (in some examples, the local agents calculate the local loss functions (loss function 1 and loss function 2) and transmit the local loss functions to the global agent). The global agent 703 then determines the combined loss function.

The global agent 703 may then minimise the combined loss function as described with reference to FIG. 2. In this example, the global agent 703 may then compute the action taken by individual agents such that the global reward is maximized (i.e. the combined loss function is minimised). The action may then be transmitted to both local agents.

3—Multi Agent Having a Shared State Space, where the Action Space May or May not be Same, and the Reward is Measured in Same Dimension.

In this context the overall state space available to the local agents may be same or partially same. The rewards are also measured in same dimension. Hence there may be a need to optimize the total cost and plan efficiently so as to exploit the rewards collaboratively without competing for them.

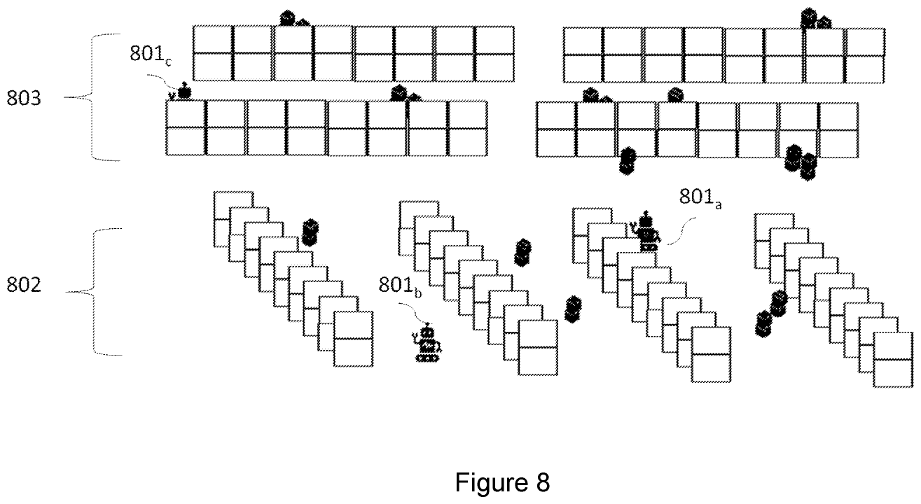

An example of this scenario is illustrated in FIG. 8. Multiple floor robots 801a to 801c on a warehouse floor are trying to arrange items where they need to plan each episode collaboratively with each other. Hence the global system needs to be designed in such a way that two robots do not attempt to fetch the same item.

Imagine a warehouse where items are to be moved from the floor of the warehouse to shelving 802 or to transportation 803 where they are to be arranged in racks.

The robots 801a to 801c are aware of the items lying on the floor of the warehouse by the use of sensors, and the robots then each use a local RL model to plan to put the objects into the racks in the minimum possible time expending the minimum amount of energy. Therefore, each robot gets a certain positive reward for putting an item in the rack, and a small negative reward for each step taken (given energy is expended). In this example therefore both the first local agent (in one robot) and the second local agent (in another robot) have the same or similar local RL models with the same aim.

The global goal is for the robots to collectively put all the boxes in the racks in fastest possible way whilst expending the minimum amount of total energy. Whilst individual robots may need to be efficient, it may also be beneficial to ensure that each robot does not attempt to pick up an object at the same time as another robot. Also, by utilising heuristics, it may be possible to keep the robots as far apart as possible so that they can collectively scan the as much of the room as possible in any time instance. Here the overall reward would be optimized by combined loss function which tries to reduce the number of items on the floor while at the same time the regularisation component ensures the robots do not come close to each other and do not exploit the same location (which would be sub-optimal). In other words, the regularisation component ensures that the robots do not enter the same state and attempt to execute a common action from that state.

5G Slicing Examples

In 5G slicing each network slice may be controlled by a local agent. Each local agent may try to obtain as many resources as possible to meet the requirements of the slice. But utilizing the claimed invention to solve a combined loss function for a plurality of network slices, a trade-off between the services provided by the slices can be achieved.

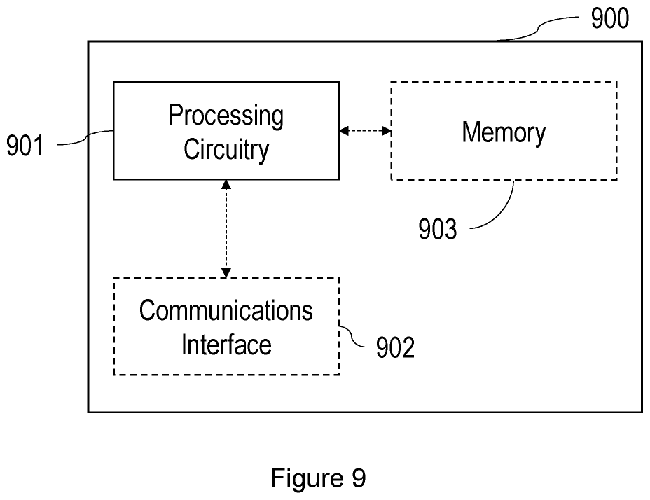

FIG. 9 illustrates a global agent 900 comprising processing circuitry (or logic) 901. The processing circuitry 901 controls the operation of the global agent 900 and can implement the method described herein in relation to a global agent 900. The processing circuitry 901 can comprise one or more processors, processing units, multi-core processors or modules that are configured or programmed to control the global agent 900 in the manner described herein. In particular implementations, the processing circuitry 901 can comprise a plurality of software and/or hardware modules that are each configured to perform, or are for performing, individual or multiple steps of the method described herein in relation to the global agent 900. The global agent 900 may be configured to perform the method as described with reference to FIG. 2.

Briefly, the processing circuitry 901 of the global agent 900 is configured to: obtain a plurality of loss functions comprising: a first loss function associated with a first reinforcement learning, RL, model performed by a first local agent, wherein the first loss function is a function of one or more first parameters; and a second loss function associated with a second RL model at a second local agent, wherein the second loss function is a function of one or more second parameters; determine a combined loss function based on the plurality of loss functions; minimize the combined loss function with respect to the first parameters and the second parameters to determine updated values for the first parameters and updated values for the second parameters; initiate execution of a first updated action by the first local agent based on the updated values of the first parameters; and initiate execution of a second updated action by the second local agent based on the updated values of the second parameters.

In some embodiments, the global agent 900 may optionally comprise a communications interface 902. The communications interface 902 of the global agent 900 can be for use in communicating with other nodes, such as other virtual nodes. For example, the communications interface 902 of the global agent 900 can be configured to transmit to and/or receive from other nodes requests, resources, information, data, signals, or similar. The processing circuitry 901 of global agent 900 may be configured to control the communications interface 902 of the global agent 900 to transmit to and/or receive from other nodes requests, resources, information, data, signals, or similar.

Optionally, the global agent 900 may comprise a memory 903. In some embodiments, the memory 903 of the global agent 900 can be configured to store program code that can be executed by the processing circuitry 901 of the global agent 900 to perform the method described herein in relation to the global agent 900. Alternatively, or in addition, the memory 903 of the global agent 900, can be configured to store any requests, resources, information, data, signals, or similar that are described herein. The processing circuitry 901 of the global agent 900 may be configured to control the memory 903 of the global agent 900 to store any requests, resources, information, data, signals, or similar that are described herein.

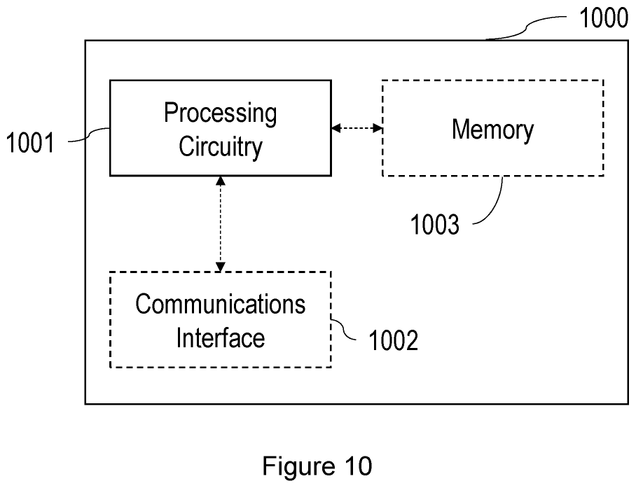

FIG. 10 illustrates a local agent 1000 comprising processing circuitry (or logic) 1001. The processing circuitry 1001 controls the operation of the local agent 1000 and can implement the method described herein in relation to a local agent 1000. The processing circuitry 1001 can comprise one or more processors, processing units, multi-core processors or modules that are configured or programmed to control the local agent 1000 in the manner described herein. In particular implementations, the processing circuitry 1001 can comprise a plurality of software and/or hardware modules that are each configured to perform, or are for performing, individual or multiple steps of the method described herein in relation to the local agent 1000. The local agent 1000 may be configured to perform the method as described with reference to FIG. 2.

Briefly, the processing circuitry 1001 of the local agent 1000 is configured to: transmit, to a global agent, either a loss function associated with the RL model or a replay experience of the agent, wherein the replay experience comprises a state, an action, a reward and a next state, wherein the action is determined based on a maximum Q-value for the state given current values of parameters of the environment; transmit current values of the parameters to the global agent; receive updated values of the parameters from the global agent; determine an updated action based on the updated values of the parameters; and perform the updated action.

In some embodiments, the local agent 1000 may optionally comprise a communications interface 1002. The communications interface 1002 of the local agent 1000 can be for use in communicating with other nodes, such as other virtual nodes. For example, the communications interface 1002 of the local agent 1000 can be configured to transmit to and/or receive from other nodes requests, resources, information, data, signals, or similar. The processing circuitry 1001 of local agent 1000 may be configured to control the communications interface 1002 of the local agent 1000 to transmit to and/or receive from other nodes requests, resources, information, data, signals, or similar.

Optionally, the local agent 1000 may comprise a memory 1003. In some embodiments, the memory 1003 of the local agent 1000 can be configured to store program code that can be executed by the processing circuitry 1001 of the local agent 1000 to perform the method described herein in relation to the local agent 1000. Alternatively, or in addition, the memory 1003 of the local agent 1000, can be configured to store any requests, resources, information, data, signals, or similar that are described herein. The processing circuitry 1001 of the local agent 1000 may be configured to control the memory 1003 of the local agent 1000 to store any requests, resources, information, data, signals, or similar that are described herein.

Embodiments described herein therefore provide methods and apparatuses to solve multi-objective RL problem which can solve two or more local agents simultaneously to obtain trade-off between two or more local agents. Furthermore, some embodiments described herein provide a combined loss function having a regularisation component designed to handle conflicting situations among local agents.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A computer-implemented method of controlling a multi-agent reinforcement learning environment, the method comprising:
obtaining a plurality of loss functions comprising:
a first loss function associated with a first reinforcement learning, RL, model performed by a first local agent, wherein the first loss function is a function of one or more first parameters; and
a second loss function associated with a second RL model at a second local agent, wherein the second loss function is a function of one or more second parameters;
determining a combined loss function based on the plurality of loss functions;
minimizing the combined loss function with respect to the first parameters and the second parameters to determine updated values for the first parameters and updated values for the second parameters;
initiating execution of a first updated action by the first local agent based on the updated values of the first parameters; and
initiating execution of a second updated action by the second local agent based on the updated values of the second parameters.

2. The computer-implemented method as claimed in claim 1 wherein the first loss function is calculated based on a first replay experience of the first local agent, wherein the first replay experience comprises a first state, s_{1,t} a first action, a_{1,t}, a first reward, r_{1,t+1}, and a first next state, s_{1,t+1}.

3. The computer-implemented method as claimed in claim 2 wherein the second loss function is calculated based on a second replay experience of the second local agent, wherein the second replay experience comprises a second state, s_{2,t+1} a second action, a_{2,t}, a second reward, r_{2,t+1}, and a second next state, s_{2,t+1}.

4. The computer-implemented method as claimed in claim 3 wherein the combined loss function further comprises a regularization component, wherein the value of regularization component increases when the first next state, s_{1,t+1} and the second next state, s_{2,t+1}, are closer together.

5. The computer-implemented method as claimed in claim 4 further comprising determining the regularization component by determining a distance, d(s_{1,t+1}, s_{2,t+1}), between the first next state and the second next state by:
for each action in the combination of all available actions in the first state and the second state:
calculating a reward difference as a magnitude of a difference between local rewards obtained from the first next state and the second next state after applying the action; and
calculating a Kantorovich distance between the probability of transitioning into the first next state based on the first state and the first action, and the probability of transitioning into the second next state based on the second state and the second action; and
calculating a distance sum for the action by summing the reward difference and the Kantorovich distance; and
setting the distance between the first next state and the second next state as the distance sum with the maximum value.

6. The computer-implemented method as claimed in claim 5 wherein the plurality of loss functions comprises N loss functions, where N is an integer, each associated with a respective RL model performed by an i^{th} agent, where i=1, . . . , N wherein the i^{th} loss function is calculated based on a i^{th} replay experience of the i^{th} agent, wherein the i^{th} replay experience comprises an i^{th} state, an i^{th} action, an i^{th} reward and an i^{th} next state; and wherein the step of determining the regularization component comprises:
calculating distances between each combination of possible pairs of states in: the first next state to the N^{th} next state;
calculating a Frobenius norm of a matrix comprising the distances;
setting the regularization component as a square of the Frobenius norm divided by 2.

7. The computer-implemented method as claimed in claim 4 wherein the combined loss function comprises a sum of each of the plurality of loss functions plus the regularization component.

8. The computer-implemented method as claimed in claim 7 wherein the sum of each of the plurality of loss functions is a weighted sum, wherein each loss function is associated with a weighting factor, βᵢ.

9. The computer-implemented method as claimed claim 7 wherein the regularization component is multiplied by a regularization weighting factor, δ.

10. The computer-implemented method as claimed in claim 1 wherein the updated first action is determined based on the action that provides the first local agent with greatest Q-value in the first RL model given the first next state and the updated first parameters.

11. The computer-implemented method as claimed in claim 1 wherein the updated second action comprises the action that provides the second local agent with the greatest Q-value in the second RL model given the second next state and the updated second parameters.

12. The computer-implemented method as claimed in claim 1 wherein the first local agent is configured to control a transmission power of an antenna to decrease a Signal-to-Interference-plus-Noise Ratio, SINR, of the antenna, and the second local agent is configured to control a tilt of an antenna to decrease the SINR of the antenna.

13. The computer-implemented method as claimed in claim 1 wherein the first local agent is configured to control radio access network counters to minimize handover rate in the radio access network, and the second local agent is configured to control radio access network counters to maximize Reference Signal Received Power, RSRP, values in the network.

14. The computer-implemented method as claimed in claim 1 wherein the first local agent is configured to control obtaining resources for a first network slice to meet network requirements of the first network slice, and the second local agent is configured to control obtaining resources for a second network slice to meet network requirements of the second network slice

15. A method in a local agent, wherein the local agent is configured to perform a reinforcement learning, RL, model in an environment, the method comprising:
transmitting, to a global agent, either a loss function associated with the RL model or a replay experience of the agent, wherein the replay experience comprises a state, an action, a reward and a next state, wherein the action is determined based on a maximum Q-value for the state given current values of parameters of the environment;
transmitting current values of the parameters to the global agent;
receiving updated values of the parameters from the global agent;
determining an updated action based on the received updated values of the parameters; and
performing the updated action.

16. The method as claimed in claim 15 wherein the local agent is configured to control one of:
a transmission power of an antenna to decrease a Signal-to-Interference-plus-Noise Ratio, SINR, of the antenna; or
a tilt of an antenna to decrease the SINR of the antenna.

17. The method as claimed claim 15 wherein the local agent is configured to control one of:
radio access network counters to minimize handover rate in the radio access network; or
radio access network counters to maximize Reference Signal Received Power, RSRP, values in the network.

18. The method as claimed in claim 15 wherein the local agent is configured to control obtaining resources for a network slice to meet network requirements of the network slice.

19. A global agent for controlling a multi-agent reinforcement learning environment, the global agent comprising processing circuitry configured to:
obtain a plurality of loss functions comprising:
a first loss function associated with a first reinforcement learning, RL, model performed by a first local agent, wherein the first loss function is a function of one or more first parameters; and
a second loss function associated with a second RL model at a second local agent, wherein the second loss function is a function of one or more second parameters;
determine a combined loss function based on the plurality of loss functions;
minimize the combined loss function with respect to the first parameters and the second parameters to determine updated values for the first parameters and updated values for the second parameters;
initiate execution of a first updated action by the first local agent based on the updated values of the first parameters; and
initiate execution of a second updated action by the second local agent based on the updated values of the second parameters.

20. The global agent as claimed in claim 19 wherein the first loss function is calculated based on a first replay experience of the first local agent, wherein the first replay experience comprises a first state, s_{1,t} a first action, a_{1,t}, a first reward, r_{1,t+1}, and a first next state, s_{1,t+1}.

21.-24. (canceled)
